(19) United States
(12) Patent Application Publication
(10) Pub. No.: US 2002/0165772 A1
(43) Pub. Date: Nov. 7, 2002

(54) Settlement system and server apparatus

(76) Inventors: Eiji Nakazawa, Tokyo (JP); Yoshiyuki Kato, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(21) Appl. No.: 09/980,232

(22) PCT Filed: Mar. 27, 2001
(86) PCT No.: PCT/JP01/02496

(30) Foreign Application Priority Data
Mar. 28, 2000 (JP) 2000-89042
Sep. 26, 2000 (JP) 2000-291877

(51) Int. Cl. G06F 17/60

(52) U.S. Cl. 705/14

(57) ABSTRACT

There is disclosed a settlement system in which predetermined image data is transmitted beforehand to a purchaser client (1, 2, . . . N) as a substitute for a commodity ticket, a coupon ticket or cash, and the client transmits the image data to a virtual shop when purchasing a commodity in the virtual shop opened on Internet, and can settle commodity purchase on the Internet (10), so that the client can use the image data to buy the arbitrary commodity on the Internet. Moreover, a server apparatus (21) for transmitting the image data to the purchaser client is provided with a program for verifying and settling whether or not the same image data as the image data transmitted to the client has been received, so that the image data can be prevented from being mistaken or abused.

### TECHNICAL FIELD

1. Field of the Invention

The present invention relates to a settlement system at a virtual shop at which a commodity is purchased and a price for the commodity is paid in the virtual shop disposed on a network such as Internet, and a server apparatus for managing the settlement system.

### BACKGROUND ART

2. Description of the Related Art

With development of a network such as Internet, in a corporation in which a commodity is sold, a virtual shop (also called an electronic mall) for selling the commodity is opened on Internet, so that shopping can be performed via Internet.

On the other hand, it is remarkably popular to obtain a present for free on Internet, answer a quiz question, fill a questionnaire, or announce one's candidacy for a monitor regarding use of the commodity, that is to make an application for the present, quiz, questionnaire, monitor, or the like. Because one can participate in a lottery for free, and can sometimes win some prize in the lottery.

When one participate in the virtual shop to purchase the commodity, a credit card is frequently utilized to pay for the commodity. However, in case of payment via the credit card, an identification number or another secret data has to be informed. A general user which purchases the commodity (hereinafter referred to as a client) is disadvantageously worried about safety of the secret data, which inhibits the virtual shop from being further developed.

Moreover, in many of general shops for actually selling the commodity, a predetermined sheet is stamped for every purchase of the commodity, and a discount ticket or coupon is distributed, so that a customer becomes a repeater to visit the shop again. However, it has been difficult to employ such system in the virtual shop on Internet, because an article corresponding to the stamp, the discount ticket, the coupon, or the like cannot be distributed.

On the other hand, for the application to a quiz, for example, the prize can be obtained for nothing, but the prize is sometimes not necessarily what one wants to have, and an unnecessary article is obtained in some cases. Therefore, if the won prize can be what one wants to have, popularity is further enhanced, and the network technique of Internet is further developed, but such system has not been realized.

### DISCLOSURE OF INVENTION

The present invention has been developed to solve the aforementioned problem, and an object thereof is to provide a settlement system in which a service corresponding to a stamp, a discount ticket, a coupon, or the like can be presented even on a network.

Moreover, an object of the present invention is to provide a server apparatus for managing the settlement system on network.

Furthermore, an object of the present invention is to provide a system in which a desired commodity can be obtained in various applications, a settlement system in which no uncertainty is given to a client in a virtual shop, or a server apparatus for managing the system.

To achieve the aforementioned objects, according to the present invention, there is provided a settlement system comprising: transmission means for transmitting image data including a money amount to a purchaser client via network; reception means for receiving the image data including the money amount from the purchaser client via the network; verification means for checking whether or not the image data including the money amount received from the purchaser client via the reception means is the transmitted image data including the money amount; and settlement means for allowing the purchaser client to settle an account in a range of the money amount via the image data including the money amount when the verification means verifies that the image data is the transmitted image data including the money amount.

That is, in the present invention, instead of sending an article to a client, image data including the money amount is transmitted to the client as money on network, and the client can advantageously use the image data to purchase an arbitrary commodity on the network. Moreover, for a transmitter, it is checked whether or not the same image data as the transmitted image data including the money amount is received, and the account is settled, so that the image data can be prevented from being mistaken or abused.

### BRIEF DESCRIPTION OF DRAWINGS

For a better understanding of the present invention, reference is made of a detailed description to be read in conjunction with the accompanying drawings, in which:

FIGS. 1 to 14 show a first embodiment of the present invention, and

FIG. 1 is a system diagram showing a relation among an information terminal, network and server.

FIG. 2 is a block diagram showing a detailed constitution of a server apparatus 21 of FIG. 1.

FIG. 3 is a diagram showing a detailed constitution of questionnaire data storage means 26 of the server apparatus 21.

FIG. 4 is a flowchart showing a procedure and content of questionnaire advertisement according to the present invention.

FIG. 5 is a diagram showing a display example of questionnaire advertisement open to the public on a home page of a service company.

FIG. 6 is a diagram showing a display example of image data for use in the present system.

FIG. 7 is a diagram showing another display example of image data for use in the present system.

FIG. 8 is a diagram showing details of a winner DB27 of the server apparatus 21.

FIG. 9 is a diagram showing a display example of a virtual shop home page of the service company on Internet.

FIG. 10 is a diagram showing details of a commodity DB28 of the server apparatus 21.

FIG. 11 is a diagram showing a display example of a commodity order table of the home page of the service company on Internet.

FIG. 12 is a similar diagram showing the display example of the commodity order table.

FIG. 13 is a diagram showing a display example of electronic mail transmission data to the service company.

FIG. 14 is a flowchart of a processing performed by control of a processing server 24.

FIGS. 15 to 29 show a second embodiment of the present invention, and

FIG. 15 is a system diagram showing the relation among the information terminal, network and server.

FIG. 16 is a block diagram showing a detailed constitution of a server apparatus 51 of FIG. 15.

FIG. 17 is a block diagram showing further detailed constitution of the server apparatus 51.

FIG. 18 is a diagram showing a detailed constitution of a member data memory 71 disposed in a data storage section 59 of the server apparatus 51.

FIG. 19 is a diagram showing a detailed constitution of an image data memory 80 disposed in the data storage section 59 of the server apparatus 51.

FIG. 20 is a diagram showing a detailed constitution of an order reception data memory 91 disposed in the data storage section 59 of the server apparatus 51.

FIG. 21 is a diagram showing a detailed constitution of a member service image data memory 100 disposed in the data storage section 59 of the server apparatus 51.

FIG. 22 is a flowchart for setting and storing image data displayed in the home page into the image data memory 80.

FIG. 23 is a diagram showing a display screen for processing the flowchart of FIG. 22.

FIG. 24 is a diagram showing the image data set and stored by the processing of the flowchart of FIG. 22.

FIG. 25 is a similar diagram showing the image data set and stored by the processing of the flowchart of FIG. 22.

FIG. 26 is a similar diagram showing the image data set and stored by the processing of the flowchart of FIG. 22.

FIG. 27 shows a display example of the virtual shop disposed in the home page.

FIG. 28 is a flowchart of a processing performed by control of the server apparatus 51.

FIG. 29 is a detailed flowchart of an order reception processing of FIG. 28.

### BEST MODE FOR CARRYING OUT OF THE INVENTION

Referring now to drawings, various preferred embodiments of the present invention will be described in detail.

First Embodiment

An example of a first embodiment of the present invention will be described hereinafter with reference to the drawings.

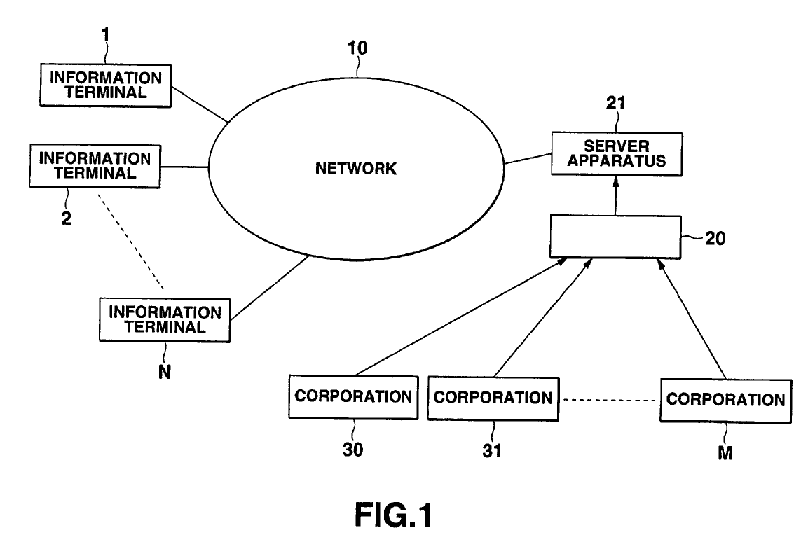

In FIG. 1, personal computers 1, 2, . . . , N as respective client information terminals in individual houses and offices are connected to a network 10 such as Internet via a public telephone network (not shown) and the like by a contract made with a provider (not shown). The network 10 is connected to a computer including a server apparatus 21, described later, of a service company 20 which advertises, for example, for questionnaire, commodity present, quiz, monitor, and the like. In the server apparatus 21, a home page or the like is opened to invite public participation in questionnaire inquiry, commodity present, quiz, and monitor (hereinafter referred to as “client participation”) via Internet. Moreover, the server apparatus can receive and store an electronic mail as an answer to each client advertisement.

Request content data from respective corporations 30, 31, . . . , M which ask for the client participation, for example, in questionnaire inquiry are sent to the service company 20 via mail, facsimile, electronic mail, and the like. The service company 20 prepares and opens to the public a home page for collecting answers to the questionnaire inquiry based on these data. Additionally, a virtual electronic shopping mall called a virtual shop is also opened in the home page as described later.

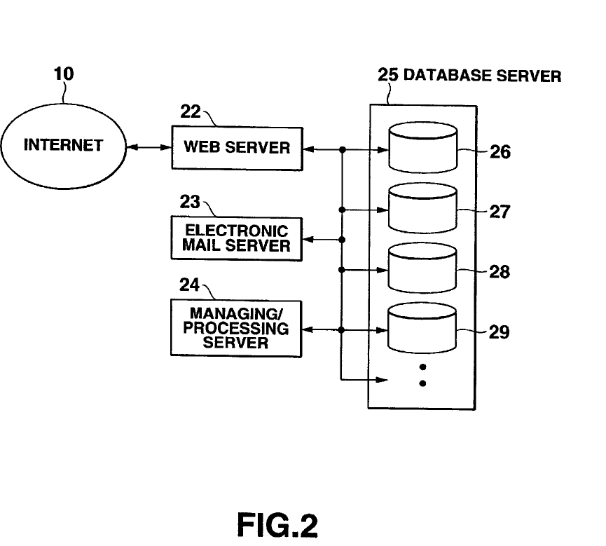

FIG. 2 shows a detail of the server apparatus 21 of the service company. The server apparatus is provided with: a Web server 22, connected to the network 10 such as Internet, for transmitting and receiving data with respect to the network 10 via the telephone network; an electronic mail server 23 for transmitting/receiving an electronic mail; and a managing/processing server 24 for managing data of a database server 25 described later and using the respective data to perform various processings. These servers are connected to one another via a cable, or the like.

Additionally, excluding the database server 25, as not shown, each of the servers is provided with a display apparatus such as a CRT or a large-sized LCD, input means such as a keyboard, mouse, and scanner, means for attaching an external memory, an internal memory, and CPU, and executes respective functions.

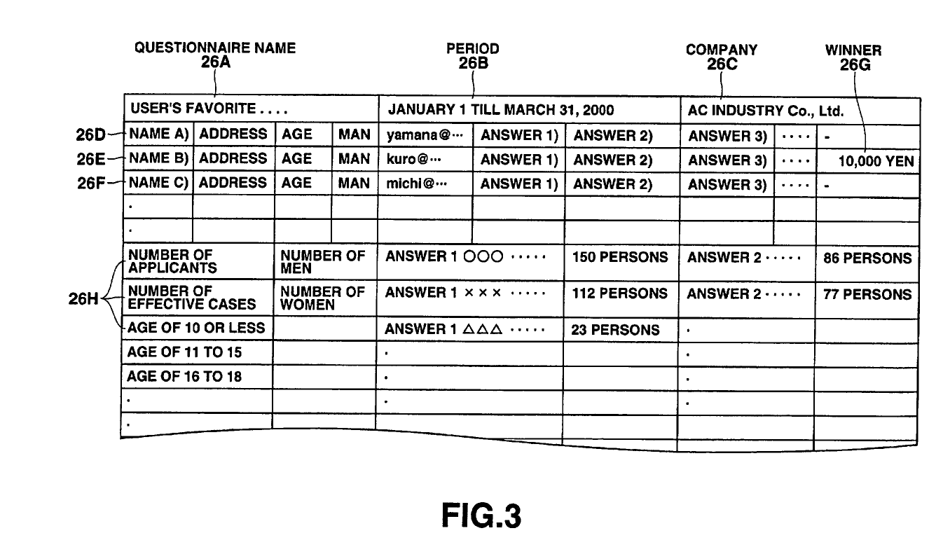

The database server 25 is provided with questionnaire data storage means (hereinafter referred to as questionnaire DB) 26 for storing data such as questions and answers regarding questionnaire performed by the service company. The questionnaire DB 26 is constituted, for example, of a large-capacity RAM, ROM, hard disk or optical magnetic disk as shown in FIG. 3.

In FIG. 3, in a questionnaire name area 26A, a type of questionnaire to perform, and questionnaire name data are stored. In a questionnaire period area 26B, questionnaire period data is stored. Moreover, in a request corporation name area 26C, a name of a corporation or a group which has requested the service company for the questionnaire is stored.

In respective answer area rows 26D, 26E, 26F, . . . , data of those who answer the questionnaire are stored (one row indicates the data of one person). As shown without any reference numeral, areas for storing each name, address, age, and sex are disposed. Moreover, areas for storing respective answers to each question of the questionnaire (answers 1, 2, 3, . . . ) are disposed.

Furthermore, as described later, an article corresponding to a prize is sent to a winner among the questionnaire answering people by lot. In a last storage area 26G of each row, a won money amount is stored.

In an area 26H, total data of all answers to the questionnaire is stored. The managing/processing server 24 totals all answers of the answer areas 26D, 26E, 26F, . . . and stores a result in the area. As shown in FIG. 3, the total number of applicants, the number of applicants by sex, the number of applicants by age, and collected number of data of answer contents to the respective questions, and the like are stored.

As described above, the same storage areas as the storage areas 26A to 26H are disposed in the questionnaire DB 26, and questionnaire data regarding a large number of questions are stored.

Additionally, in addition to the questionnaire inquiry, to invite the client participation in applications for the commodity present, quiz, monitor, and the like, data of the participation content, and answer content are similarly stored.

Turning back to FIG. 2, the database server 25 is provided with winner data storage means (hereinafter referred to as the winner DB) 27 to store data such as prizes sent to winners selected by lot from those who answers the questionnaire. The database server is also provided with: commodity data storage means (hereinafter referred to as commodity DB) for storing image data of a commodity photograph of the virtual shop, and name, price, and the like of the commodity; and mail data storage means (hereinafter referred to as the mail DB) 29 for storing the data, and the like transmitted/received via the electronic mail.

Similarly as the questionnaire DB 26, each of the winner DB 27, commodity DB 28 and mail DB 29 is constituted of the large-capacity RAM, ROM, hard disk or optical magnetic disk. Details of the winner DB 27 and commodity DB 28 will be described later.

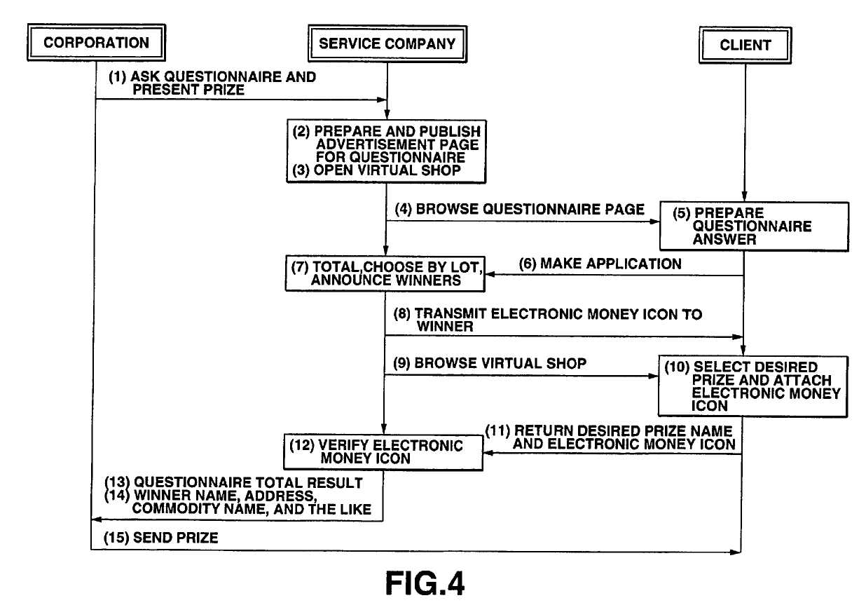

FIG. 4 shows a procedure and content for inviting the participation in the questionnaire. This processing is performed in order of steps (1) to (15) with elapse of time.

First, a corporation who wants to perform questionnaire inquiry informs the service company of a questionnaire content and a commodity or a prize to be presented to a person who makes an application for the questionnaire step (1).

The service company receives such information and places questionnaire advertisement in its own home page step ((2)), or opens a virtual shop (step(3)). Additionally, if the virtual shop is already open, the virtual shop does not have to be newly opened.

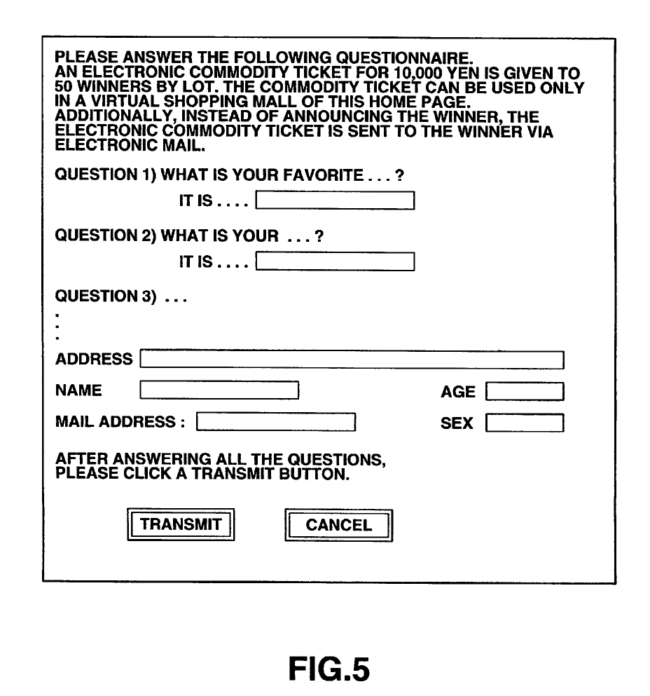

FIG. 5 shows a display example of questionnaire opened to the public in the home page of the service company. Therefore, the client making application for the questionnaire displays this home page in the client's personal computer (step (4) browses questionnaire page of FIG. 4), inputs an answer to the question, address, name, age, sex, and mail address in frames (step (5) prepares questionnaire answer), and clicks a transmit button, so that the input data is sent to the server apparatus 21 of the service company via the electronic mail, or the like by the network (6).

Subsequently, answer data sent from the respective clients are successively stored/held in the mail DB 29 via the electronic mail server 23.

After the questionnaire period, the processing server 24 collects the all answer data, and stores all answer data and totaled data in the questionnaire DB 26. Moreover, the service company chooses a winner from the applicants by lot, announces the winner in the home page, and writes won money amount data in the money amount storage area 26G of the questionnaire DB 26 (7).

In an example of FIG. 3, Mr. B whose data is stored in the area 26E has won 10,000 yen, and Messrs. A and C has drawn blanks.

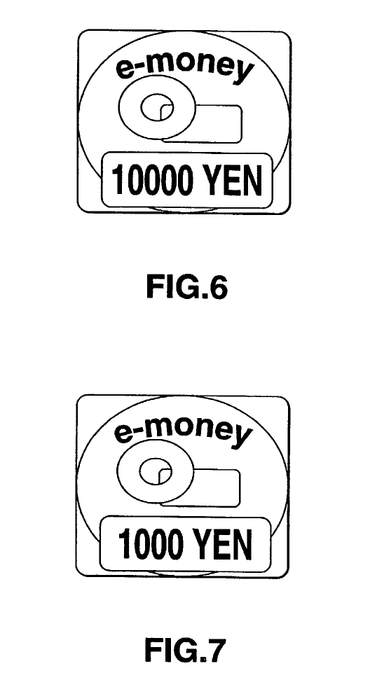

Subsequently, the processing server 24 performs a processing of transmitting the image data (icon image data) including the won money amount to the winner via the electronic mail (step (8)). FIGS. 6 and 7 show the image data (electronic money icon) including the money amount to be transmitted, FIG. 6 shows bit map data including characters indicating the money amount of 10,000 yen, and FIG. 7 shows the bit map data including characters indicating the money amount of 1,000 yen. These data are stored beforehand in a memory (not shown) of the processing server 24.

The processing server 24 encrypts verification code data, identification data, and the like comprising character data such as numerical values and characters, attaches these data to the image data, and sends the image data. Alternatively, the processing server 24 uses an electronic watermark technique to attach the encrypted watermark data to the image data, and sends the image data.

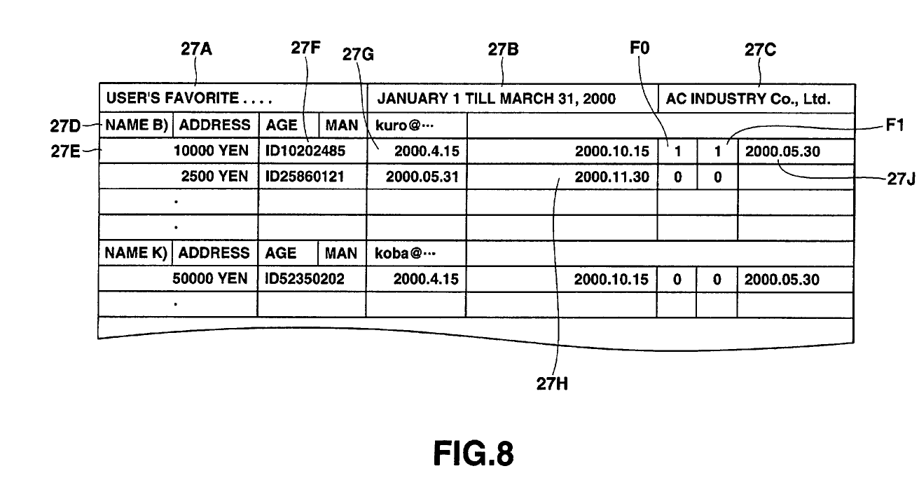

Additionally, the processing server 24 writes data into the winner DB 27. FIG. 8 shows a detail of the winner DB 27. In FIG. 8, a questionnaire name area 27A is an area in which questionnaire name data is stored, and a questionnaire period area 27B is an area in which questionnaire period data is stored. Moreover, a request corporation name area 27C is an area in which the name of a corporation or a group which has requested the service company for the questionnaire is stored.

In the next area 27D, a winner's name (name B), Mr. B's address, age, sex, electronic mail address, and other data are stored. Moreover, in a money amount area 27E, Mr. B's won money amount, for example, 10,000 yen is stored. Thus, it is stored that the image including the money amount of 10,000 yen of FIG. 6 has been sent to Mr. B.

Furthermore, in an identification data storage area 27F, encrypted data attached to the image sent to Mr. B, or identification data attached with an electronic watermark is stored. The identification data differs every time the data is issued from the processing servers 24, even if the data is the image data indicating the same money amount of 10,000 yen.

Therefore, in an area 27G, data of a date at which the image data is sent to Mr. B is stored, and in an area 27H, date data of an effective period during which Mr. B can use the image data is stored. That is, Mr. B can use the image data as described later to purchase the commodity at the virtual shop on the network, and the effective period is determined. Moreover, in a flag area F0, it is stored whether or not Mr. B has purchased the commodity with the image data. When the area F0 indicates 0, he has not purchased the commodity yet. When he purchases the commodity, 1 is stored in the area F0.

Furthermore, the price of the commodity purchased by Mr. B is not limited to 10,000 yen. For example, when he purchases the commodity of 7,500 yen, the image data for 2,500 yen is newly sent as a change. Mr. B can use the image data to purchase the commodity.

The presence of the change is stored in the flag area Fl. A date at which the commodity of 7,500 yen is purchased is stored in a purchase date storage area 27J, and 1 is stored in the flag area. In the next row, for 2,500 yen, the content of data similar to that described above is stored. Additionally, in FIG. 8, it is stored that Mr. K has won 50,000 yen and that the image data has been sent to him.

When the image data is sent, each client who has answered the questionnaire can know that he has won money, and the won money amount (yen). Subsequently, in order to purchase the commodity with the image data, the client opens the page of the virtual shop in the home page of the service company on Internet (step (9)).

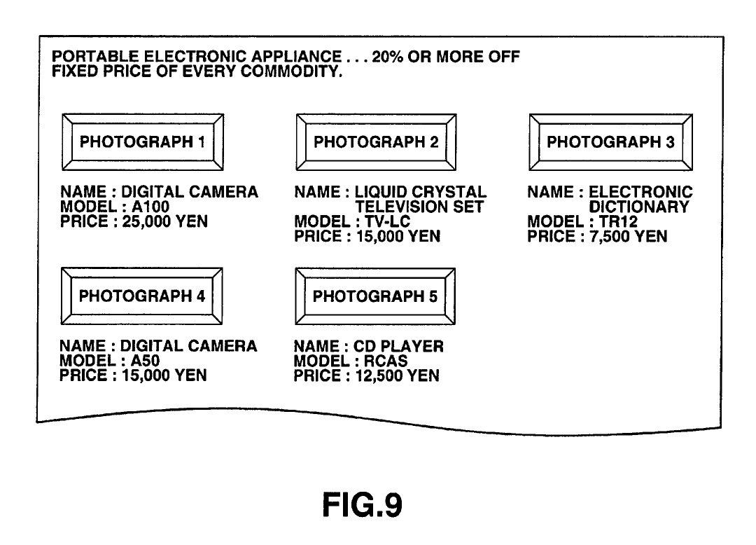

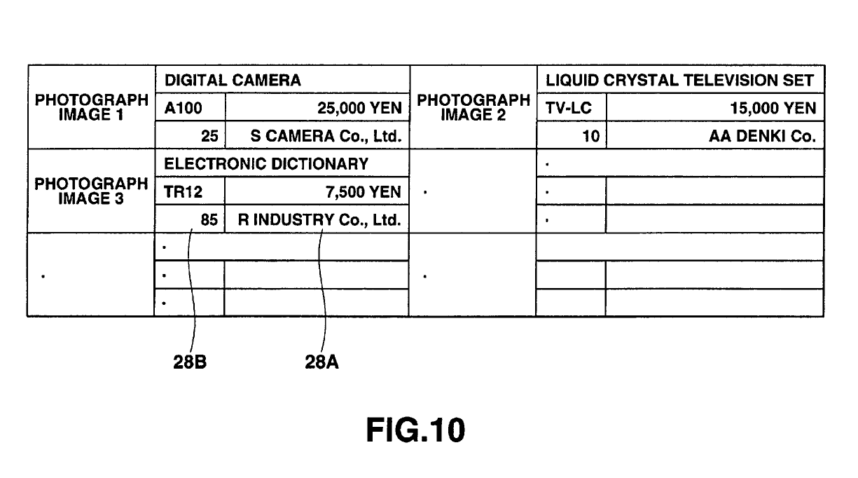

FIG. 9 shows the page of the virtual shop of the service company, and commodity data presented by each corporation is exhibited. That is, a commodity photograph image (photograph 1, photograph 2 . . . ), and data of the photograph image, such as commodity name, model number, and price are displayed. The commodity DB 28 of FIG. 2 stores commodity data shown in FIG. 9, and is constituted as shown in FIG. 10. In FIG. 10, the commodity photograph image (photograph 1, photograph 2 . . . ), and data such as commodity name, model number and price are stored. Moreover, a storage area of a name of a maker company having presented the commodity (28A), a storage area of the number of commodities in stock (28B), and another storage area are disposed.

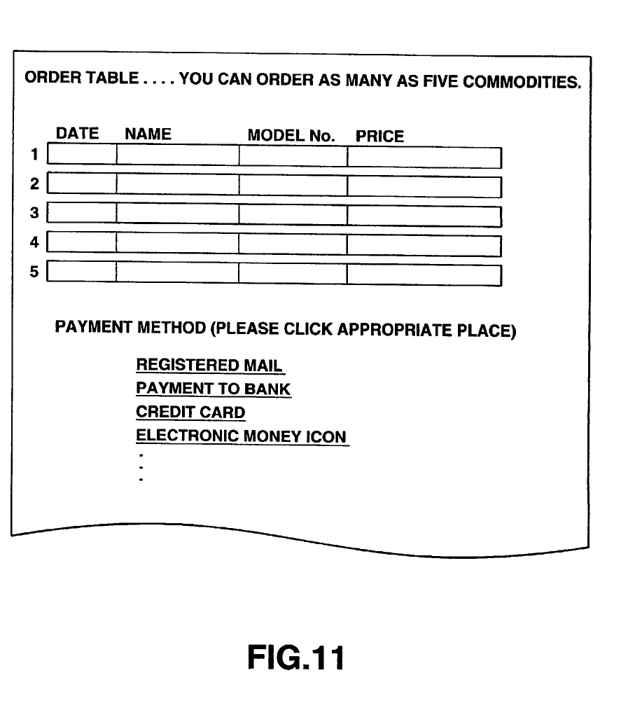

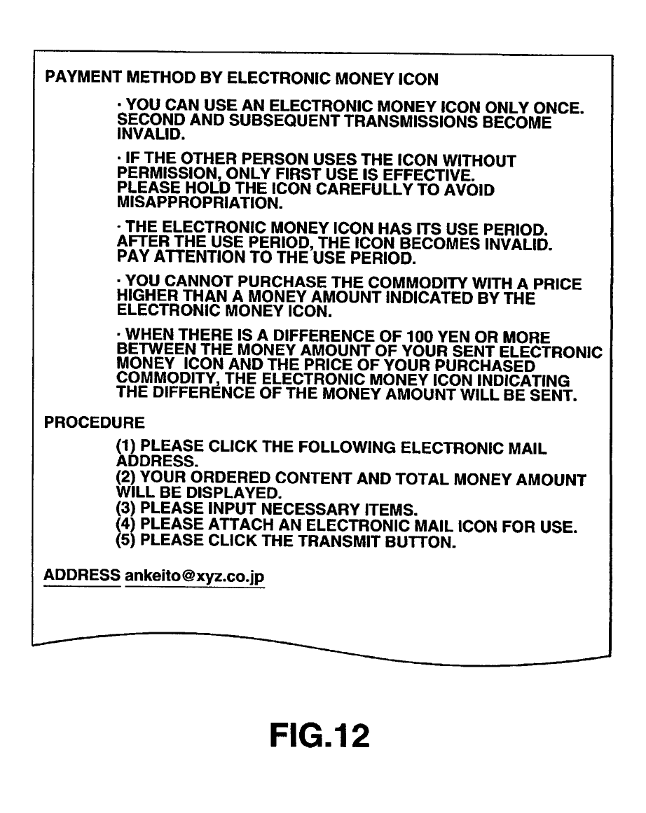

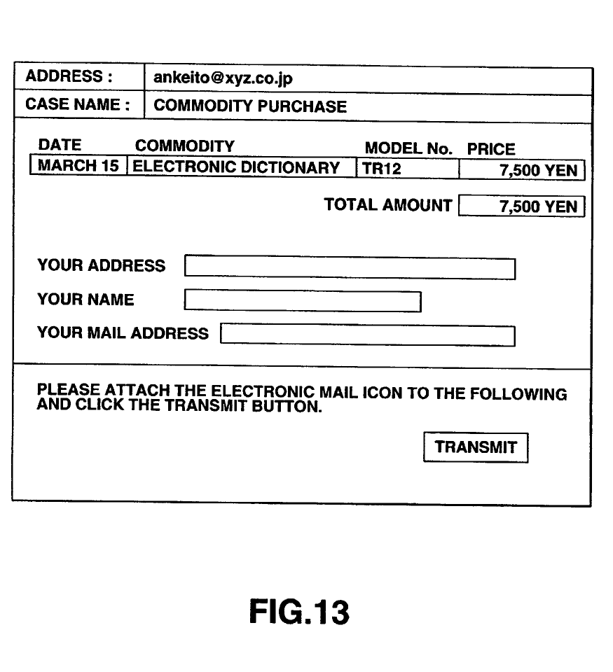

In FIG. 9, when the commodity to purchase is determined, and a cursor is aligned with a display button (not shown) with a mouse, and clicked, input display is changed to an order table shown in FIG. 11. Here, the present date, and the name, model number, price, and the like of the commodity to purchase are set (selection or key input), and the electronic money icon is clicked as a payment method, the display changes to that shown in FIG. 12. Subsequently, an electronic mail address “ankeito@xyz.co.jp” of the service company is clicked in accordance with description, and electronic mail transmission data to the service company is displayed as shown in FIG. 13.

In FIG. 13, data inputted in FIG. 11 is copied as it is, total amount is also displayed, and a frame for inputting a transmission client address, name, and mail address is further displayed. Subsequently, the client's address, name, and mail address are inputted into the frame, and the electronic money icon already sent as the won money amount is attached (step (10)).

Thereafter, when the transmit button is clicked, display content of FIG. 13 and the electronic money icon are transmitted to the service company via the electronic mail (step (11)).

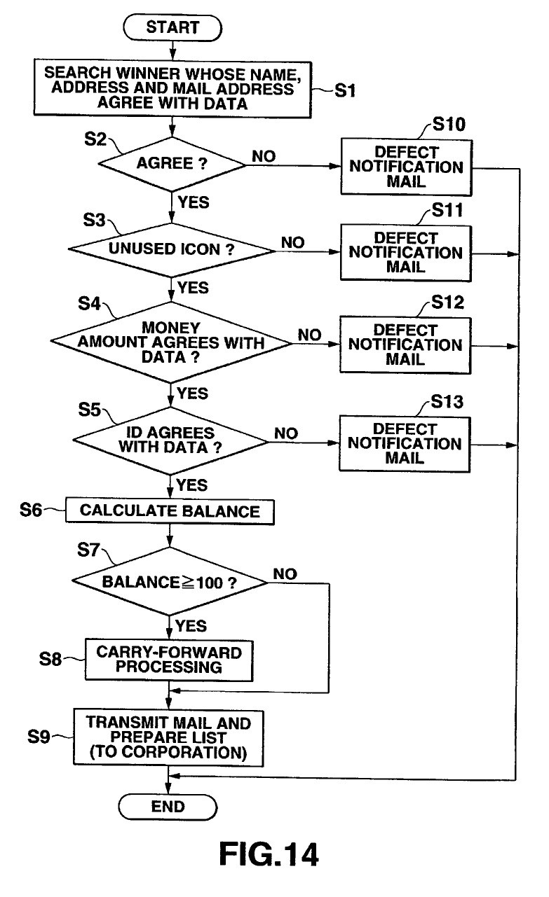

It is verified in the service company whether or not the electronic money icon sent via the electronic mail is authentic. This processing is performed as shown in a flowchart of FIG. 14 under the control of the processing server 24.

In FIG. 14, first in step Si, it is judged whether or not the same data as those of the address, name, and electronic mail address of the electronic mail sent from the client exist in the winner DB 27. Subsequently, when the agreeing data exist, that is, when answer to step S2 is yes, the processing advances to step S3. It is then detected whether or not the flag area F0 indicates 0. That is, in the money amount data sent to the client and stored in the money amount area 27E, it is detected whether or not the flag area F0 indicates 0, that is, whether or not there is an electronic money icon unused by the client in the virtual shop. If yes (Y), the processing advances to step S4.

In the step S4, it is judged whether or not the sent total amount of the commodity purchase is equal to or less than the money amount of the unused money amount data. If yes (Y), the processing advances to step S5.

In the step S5, it is judged whether or not the identification data attached to the sent electronic money icon agrees with the identification data stored in the identification data storage area 27F. When the data agree with each other, it is judged that the electronic money icon sent to the winner is returned as it is and that the electronic money icon is authentic. Then, the processing advances to the following step S6.

In the step S6, a difference between the money amount data stored in the money amount area 27E and the sent total amount of the commodity purchase, that is, a change is calculated. If the difference is equal to or more than 100 yen in the following step S7, a carry-forward processing is performed in the following step S8. In the carry-forward processing of the step S8, the image data including the money amount corresponding to the amount of the change (electronic money icon) is transmitted to the client, and it is registered in the winner DB 27 that the new electronic money icon has been sent.

After the processing ends, or when the amount is equal to or less than 100 yen in step S7, the processing advances to step S9 to prepare a list of purchaser name, address and commodity.

Additionally, if the answer to any one of the steps S2 to S5 is no (N), a mail indicating a reason for the result is transmitted to the client (steps S10 to S13).

As described above, when the order for commodity purchase based on the authentic electronic money icon is received and the list of the name, address and ordered commodity is prepared, the list is sent to the corporation together with the total result of the questionnaire (steps (13) and (14)). Subsequently, the corporation sends the ordered commodity to each client based on the list (step (15)). This means completion of settlement of the commodity purchase by the purchaser using the electronic money icon.

Additionally, in the aforementioned embodiment, the winner is extracted from those who have made application for the questionnaire to answer the questions, so that the winner can buy the commodity with the electronic money icon. This can similarly be performed for the free present, the quiz, or the applicant for the commodity monitor. Moreover, the money icon data can be stored in recording mediums such as a floppy disk, and a semiconductor (IC) memory, and mailed to the client, or handed over to the client at a window.

Further, the present invention can be applied not only as a reward or a prize of the questionnaire, quiz, or the like but also as a so-called prepaid system in which the electronic money icon for purchasing the commodity from the virtual shop on network such as Internet is purchased beforehand by cash and the commodity is purchased from the virtual shop with the purchased electronic money icon. In this case, the recording medium in which the electronic money icon is stored may be sold beforehand.

Moreover, the virtual shop is opened on the home page of the service company, but may be opened in the home page of each corporation so that the electronic money icon can be used to purchase the commodity.

Second Embodiment

A second embodiment of the present invention will be described hereinafter with reference to the drawings. Additionally, the same constituting portions as those of the first embodiment are denoted with the same reference numerals and detailed description thereof is omitted.

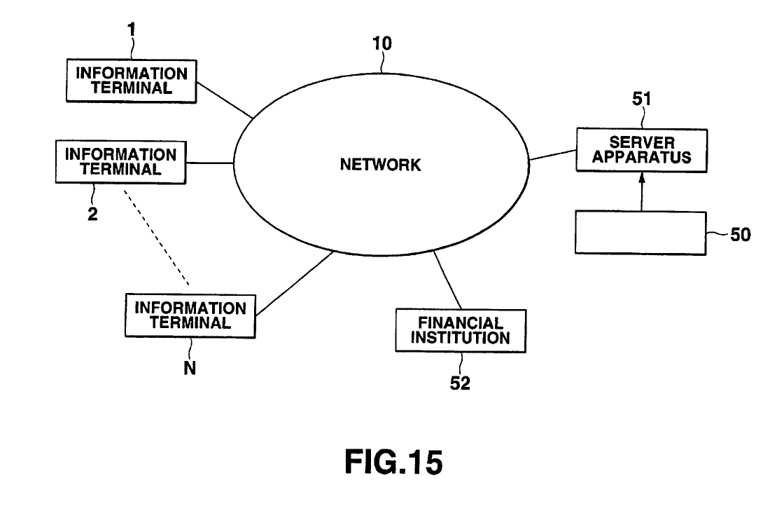

In the second embodiment, a company or a maker sells the commodity in the virtual shop (virtual mall) on Internet, and the client makes an order for the commodity so that an actual commodity is sent to the client. A network for this system is shown in FIG. 15.

In FIG. 15, a pizza shop 50 actually sells pizza, and also includes a server apparatus 51 connected to the network 10 such as Internet. Pizza orders from the personal computers 1, 2, . . . , N of the clients who have already made contracts as members are received via the network 10, and the ordered pizzas are cooked and sent to clients' homes. In this case, payment for the ordered pizza is settled by a pre-contracted financial institution 52, and the payment can partially or wholly be settled with service image data described later.

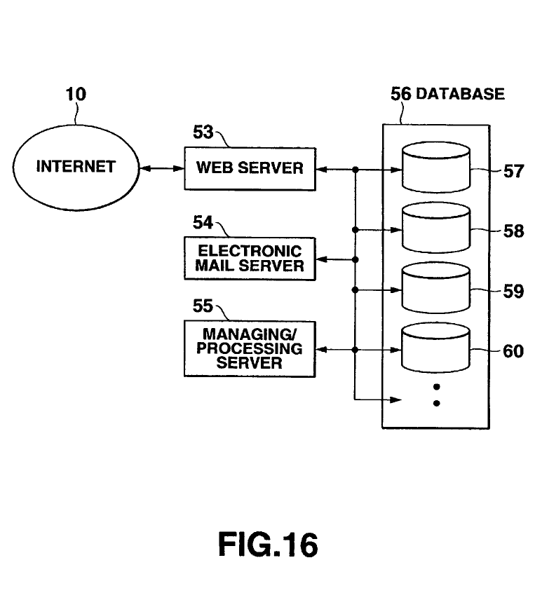

FIG. 16 shows a detail of the server apparatus 51 of the pizza shop 50. The server apparatus is provided with: a Web server 53, connected to the network 10 such as a public telephone network and Internet, for transmitting/receiving data with respect to the network 10 via the telephone network; an electronic mail server 54 for transmitting/receiving the electronic mail; and a managing/processing server 55 for managing data of a database 56 described later and using the respective data to perform various processings. These servers are connected to one another via the cable, or the like.

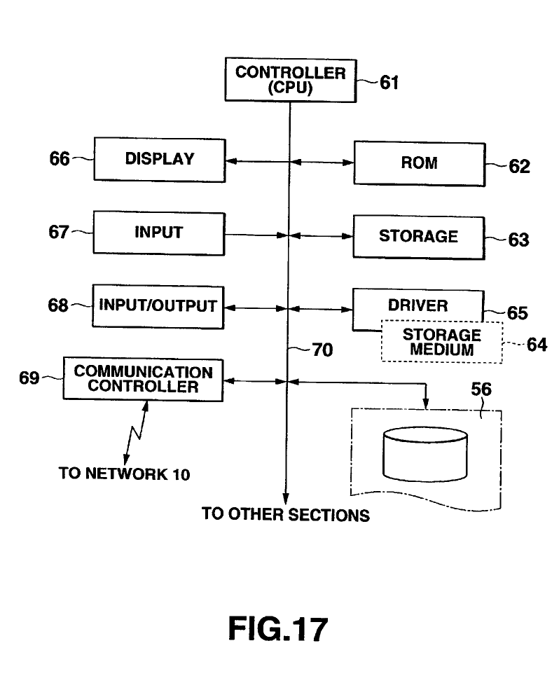

FIG. 17 is a detailed circuit block diagram, for example, of the Web server 53 among the respective servers 53 to 55. Additionally, the electronic mail server 54 and managing/processing server 55, and the Web server 22, electronic mail server 23 and managing/processing server 24 shown in FIG. 2 have constitutions similar to the constitution shown in FIG. 17, except for various programs and processing functions controlled by the programs. Therefore, detailed description of the constitution thereof is omitted.

The Web server 53 is provided with a controller (CPU) 61, ROM 62, data storage unit 63, driver 65 for driving a storage medium 64 to read/write a stored content, display 66, input unit 67, input/output unit 68 for transmitting/receiving data with respect to external apparatuses, and communication controller 69, and these respective units are connected to one another via a bus 70. Moreover, the bus 70 is also connected to the database 56 of FIG. 16.

The CPU 61 reads the system program and various control programs stored in the ROM 62, develops the programs in a work area (not shown) disposed in the storage unit 63 to execute the processing, and drives/controls the respective units. Moreover, the CPU 61 reads and executes the corresponding application from application programs stored in the ROM 62 or the storage medium 64 in response to an input signal transmitted via the input unit 67 and various accesses transmitted via the communication controller 69, and executes various processings such as data updating described later.

Furthermore, the CPU 61 outputs an input content from the input unit 67, various data stored in the storage unit 63 or the database 56, data stored in the storage medium 64, or content transmitted/received via the communication controller 69 to the display 66 such as CRT or liquid crystal display, and displays the content or the data in a display screen of the display 66.

The ROM 62 stores various system programs and controls programs executed by the CPU 61, data regarding these programs, and the like.

The storage unit 63 forms a storage area for storing the data processed by the program executed by the CPU 61, application program and data read from the storage medium 64, and the like, and a work area for temporarily storing the processing data during processing of various programs.

The driver 65 drives the storage medium 64 with the programs and data pre-stored therein to write and read these programs and data. The storage medium 64 is constituted of a magnetic or optical recording medium, or a semiconductor memory for storing the system program, various application programs for the system, database update processing program, and data processed by the respective processing programs. For example, a floppy disk, CD-ROM, MD, IC card memory, or the like may be used. This storage medium 64 can be disposed on the driver 65 in a fixed or detachable/attachable manner.

The input unit 67 is provided with various input devices such as a keyboard including character keys, numeric keys and various function keys, and pointing devices such as a mouse and a tablet, to generate an operation signal in accordance with an input operation in these input devices and outputs the signal to the CPU 61.

The display 66 is provided with the display screen and includes a CRT, a liquid crystal display, or the like as described above, and displays various images on the display screen based on display information inputted under the control of the CPU 61.

The input/output unit 68 inputs data from the external apparatus, such as digital image data from an electronic still camera and image scanner, and document data from various information apparatus terminals, via a cable or a wiring (not shown) and stores the data in the storage unit 63, or outputs the data from the storage unit 63.

The communication controller 69 is constituted of a modem, a terminal adapter (TA), and the like, and connected to the Internet network via communication circuits such as the public telephone network and ISDN network. The communication controller 69 controls the network to perform communication.

Turning back to FIG. 16, the Web server 53 is provided with the program for opening the home page of the pizza shop 50 on the network 10, and this home page constitutes a virtual shop for selling pizza (accepting orders) on the network. Moreover, the database 56 is provided with a data storage unit 57 for storing display data to be displayed in the home page. Additionally, each of the data storage unit 57 and respective data storage units 58 to 60 described later is constituted, for example, of the large-capacity RAM, ROM, hard disk or optical magnetic disk.

The data storage unit 58 of the database 56 stores mail data transmitted/received via the electronic mail server 54. The data storage unit 59 is provided with respective data storage units (memories) for storing member data, received order data, and the like. The respective servers 53 to 55 control reading/writing of the data. This structure and function will be described later in more detail. The data storage unit 60 stores other data.

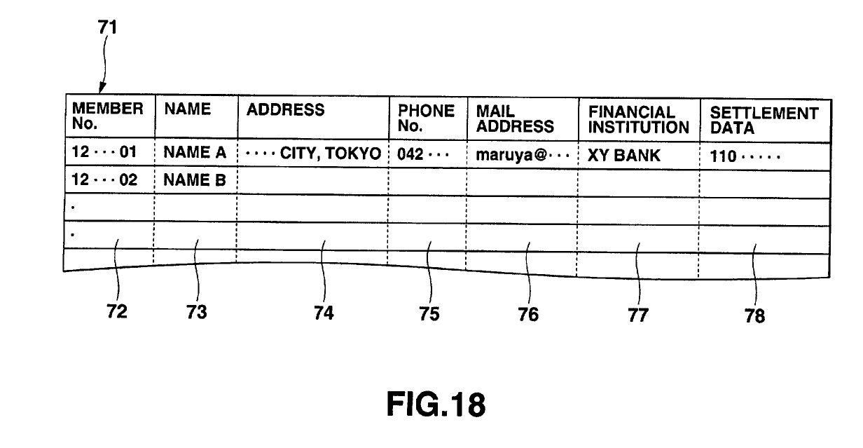

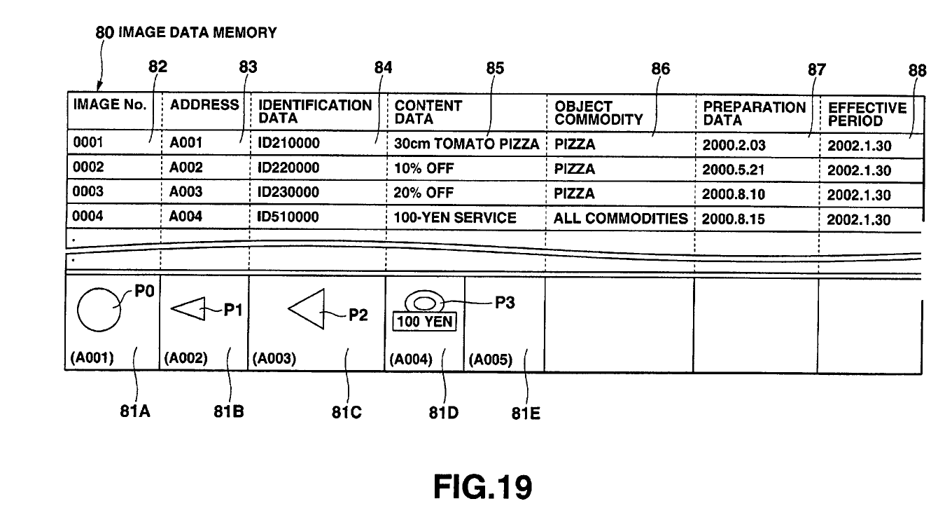

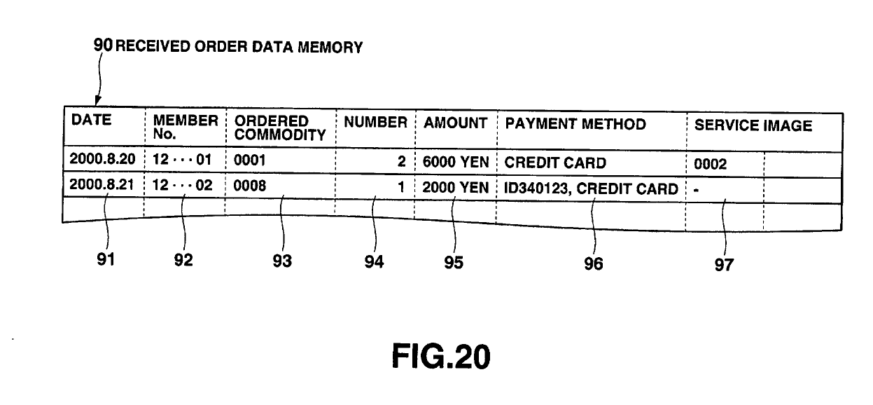

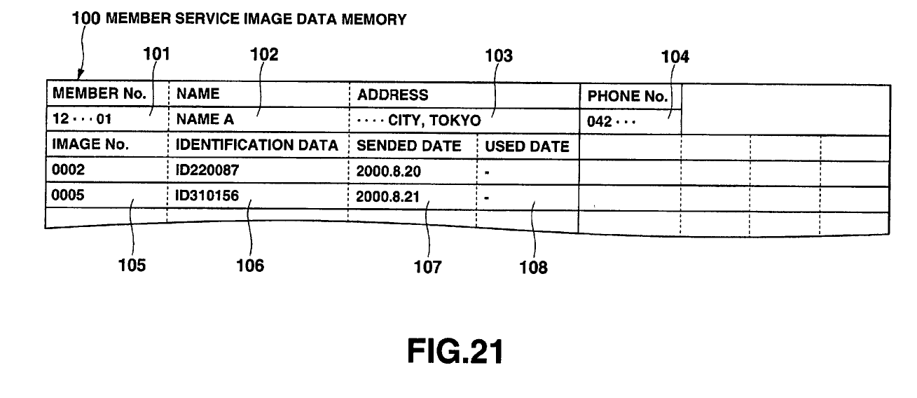

FIGS. 18 to 21 show details of respective memories of the data storage unit 59. These memories include a member data memory 71 (FIG. 18) for storing various data of pre-registered members, an image data memory 80 (FIG. 19) for pre-storing a large number of pieces of commodity (pizza) image data among the display data to be displayed in the home page as described above, a received order data memory 90 (FIG. 20) for storing content data when an order for the commodity is received via the network, and a member service image data memory 100 (FIG. 21) for storing that a discount service image has been supplied to a member having purchased the commodity.

In the member data memory 71 of FIG. 18, each row is a storage area for one member. Each row is constituted of: a member number storage area 72 for storing a member number which differs with each member; a member name storage area 73 for storing a member name; an address storage area 74; a phone number storage area 75; a mail address storage area 76 for storing an electronic mail address of the member; a financial institution storage area 77 for storing a name of a pre-contracted financial institution which settles payment of the ordered pizza; and a settlement data storage area 78 for storing settlement data by the financial institution, such as a credit card verification code number and identification number for payment from a bank account via the credit card.

In the image data memory 80 of FIG. 19, a large number of pieces of image data displayed in the virtual shop, that is, commodity (pizza) image data and associated data of the display data displayed in the home page by the server apparatus 51 of the pizza shop 50. The memory is constituted of a large number of areas 81A, 81B, 81C . . . for storing respective commodity image data (image data obtained by photographing the commodity with a digital still camera, for example) or arbitrarily prepared icon image data, and each row of the image content data storage area forms a storage area for one piece of image data. The image content data storage area includes: an image number storage area 82 for storing an image number which is set to differ with each image data; an address storage area 83 for storing storage address data A001, A002, A003, . . . of storage areas 81A, 81B, 81C, . . . in which the respective image data are stored; an identification data storage area 84 for identifying the respective image data as described later in detail; and a content data storage area 85 for storing content data of each commodity image data. Moreover, some of the respective stored image data are used in services such as commodity discount. Therefore, there are provided an object commodity data storage area 86 for storing data of the commodity to be discounted, a preparation date data storage area 87 indicating a date on which an image is prepared, and an effective period storage area 88 indicating an effective period of the service.

FIG. 20 shows a detailed constitution of the received order data memory 90 for storing the data when the order for the commodity is received from the member via Internet 10. The memory includes: a date storage area 91 for storing data of the date on which the order is received; a member number storage area 92 for storing a member number of the member having ordered the commodity; an ordered commodity storage area 93 for storing an image number of the ordered commodity as ordered commodity data; a number storage area 94 and amount storage area 95 for storing the number of ordered commodities and a total amount (unit price×number), respectively; and a payment method storage area 96 for storing data of a payment method for settling payment of the amount stored in the amount storage area 95.

Moreover, when the commodity is purchased, a service image such as a discount for each commodity is transmitted to the member having purchased the commodity. Therefore, there is also provided a service image storage area 97 for storing an image number data of the service image to be transmitted.

FIG. 21 shows details of the member service image data memory 100 for managing and storing the transmitted service image data for each member. A storage area only for one member is shown in FIG. 21. In the member service image data memory 100, a member number storage area 101, member name storage area 102, member address storage area 103 and phone number storage area 104 are disposed for one member. Moreover, data storage areas regarding a plurality of service images transmitted to the member are also disposed for the member. For each image data, the area includes an image number storage area 105 of the transmitted image data, an identification data storage area 106 for storing image identification data, a transmission date storage area 107 for storing a date on which the image is transmitted, and a use date storage area 108 for storing a date on which the image data for receiving the transmitted service is used to receive the service.

Although FIG. 21 shows the area only for one member, the member service image data memory 100 includes the aforementioned storage areas for all the members to which the service images have been transmitted.

An operation in the second embodiment constituted as described above will next be described.

First, member contracts for accepting pizza orders from the personal computers 1, 2, . . . N via the network 10 are made beforehand between the clients and the pizza shop 50. Personal information for specifying the member, settlement data such as financial institution data for settlement and verification code or identification number data for use in the settlement, and the like are stored beforehand in the member database memory 71 of FIG. 18.

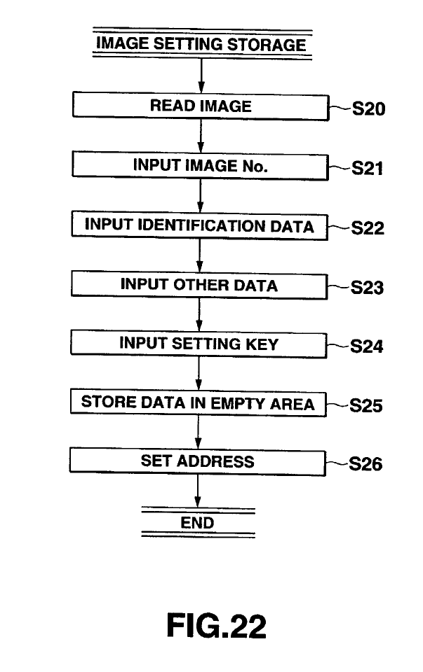

FIG. 22 shows a flowchart of an image setting/storage processing in which display commodity image data for use in display of the home page (virtual electronic shop) transmitted/received via the Web server 53 are set/stored beforehand in the image database memory 80. For example, a program for executing this processing is stored beforehand in the ROM 62 (FIG. 17) of the managing/processing server 55 or the Web server 53, and this processing flow is executed.

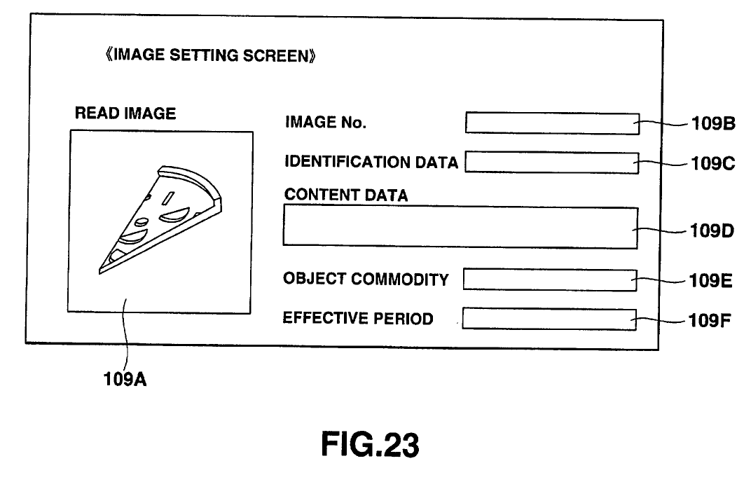

Therefore, when an image setting start button (not shown) of the input unit 67 of FIG. 17 is operated, the display 66 forms an image setting screen as shown in FIG. 23. That is, as described later, displayed are a display area 109A of an image read via the input/output unit 68, a display area 109B of image number data inputted via the input unit 67, an identification data display area 109C, a content data display area 109D, an object commodity display area 109E, and an effective period display area 109F.

In this state, first, in the image setting storage processing flow of FIG. 22, in step S20 an image reading processing is executed. In this processing, for example, the image data of the commodity photographed with the electronic still camera (not shown) is read via the input/output unit 68 of FIG. 17, stored in the work area of the storage unit 63, and further displayed in the image display area 109A of the display 66. FIG. 23 shows that an image of a one-eighth piece of the entire pizza is photographed with the camera, read, and displayed. In the next step S21, an image number is inputted. For the image number input, the number different from the number of the image number data already stored in the image number storage area 82 of the image database 80 is inputted W via the input unit 67, and this inputted data is displayed in the image number data display area 109B.

In the next step S22, identification data is inputted. By this identification data, one image is distinguished from the other image. For example, upper four digits indicate character/numeric value data (ID21, ID22, ID23, ID51 . . . ) which differ with each read image, and specify a difference of the read image. Additionally, lower four digits are all inputted as 0000 for a reason described later in detail. The inputted identification data is displayed in the display area 109C, and the flow advances to step S23. In the step S23, the content data, object commodity data, and effective period data are inputted, and the inputted data are displayed in the display areas 109D, 109E and 109F.

When the data input ends in this manner, the data is OK, and a setting button (not shown) of the input unit 67 is operated (step S24), the flow advances to step S25. In the step S25, the respective inputted data are stored in areas of the image data memory 80 in which data are not stored yet. That is, the read image data is stored, for example, in the image data storage area 81B (it is assumed that no image data has been stored here). Moreover, the inputted image number “0002”, identification data “ID220000”, content data “10% OFF”, object commodity “pizza”, and effective period “2002.1.30” are stored in a second row as shown in FIG. 19 (it is also assumed that no image data has been stored here). Furthermore, preparation date “2000.5.21 (May 21, 2000)” is stored in response to a present date signal from a clock circuit (not shown).

In the next step S26, memory address data “A002” of the storage area 81B of the extracted image data is stored in the address storage area 83 (second row), and this image setting storage flow ends.

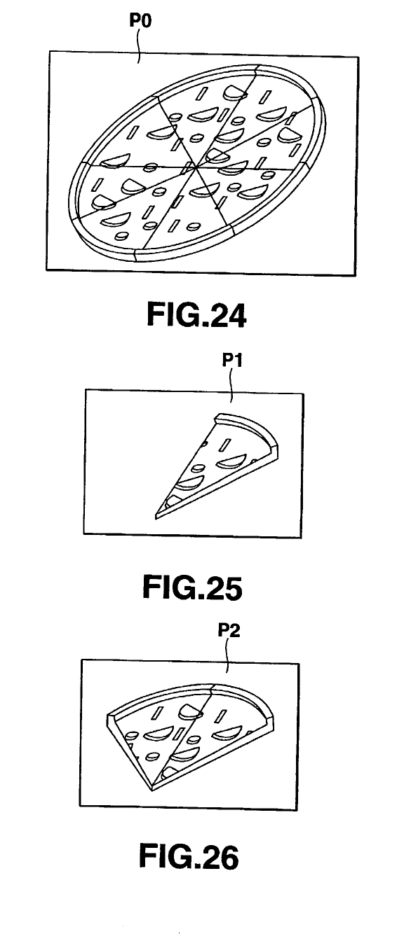

The image data for use in the home page is successively stored in the image data memory 80 in this manner. For example, an image P0 taken into the storage area 81A is image data of one entire pizza shown in FIG. 24. The content data of this image data is stored in an image number “0001” row (first row), image data P1 of the one-eighth piece of the entire pizza described above and shown in FIG. 25 is stored in the storage area 81B (content data is stored in a second row), and image data P2 of a one-fourth piece of the entire pizza shown in FIG. 26 is stored in the storage area 81C (content data is stored in a third row). Moreover, the processing of reading the image data in the step S20 may be other than reading the image data via the input/output unit 68. For example, the image pre-stored in the storage unit 63, or a bit map image prepared by oneself may be read. For example, in the storage area 81D, instead of the image data read via the input/output unit 68, an icon image P3 indicating the money amount as shown in FIG. 6 is transferred from another memory and stored (content data is in a fourth row).

The image data P0 of the whole pizza of FIG. 24 is displayed (exhibited) as an exhibition image of the commodity for sale in the virtual shop, but the image data P1 of the one-eighth piece of pizza, image data P2 of the one-fourth piece of pizza and icon image P3 including the money amount is displayed as a service image which can be used as a discount ticket for discounting a charge, exchange ticket to be exchanged for the commodity, coupon ticket, point ticket, or another service ticket. Moreover, since 10% discount only for the next purchase of pizza is possible with the image P1 of the one-eighth piece of pizza, “10% OFF” is set/stored in the content data storage area 85. Moreover, since a discount object is only the next pizza purchase, “pizza” is set/stored in the object commodity storage area 86. Moreover, the image P2 of the one-fourth piece of pizza is the same as the image of the one-eighth piece except a discount ratio.

On the other hand, with the icon image P3 of the storage area 81D, 100-yen discount is possible with all commodities other than the pizza (it is assumed that the commodities other than the pizza are also exhibited, waiting for orders in the virtual shop), and “all commodities” is therefore set as the object commodity.

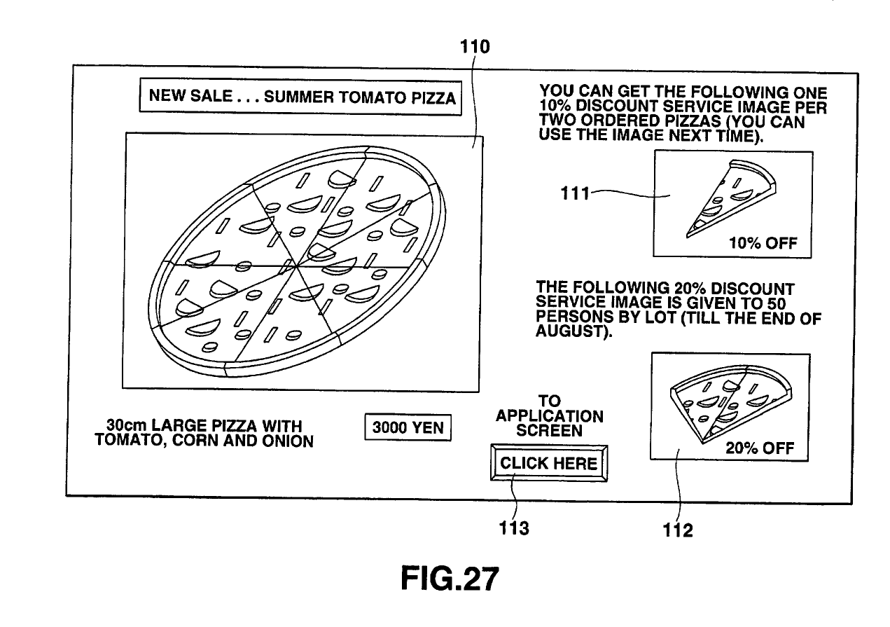

FIG. 27 shows an example of a displayed pizza image which is prepared using the image data stored in the image data memory 80, and displayed as the commodity for sale in the virtual shop of the pizza shop 50 on Internet. In FIG. 27, the image P0 of the whole pizza shown in FIG. 24 and stored in the storage area 81A of the image data memory 80 is displayed in the display area 110 to introduce the commodity. In the display area 111, the image P1 shown in FIG. 25 and stored in the storage area 81B and characters indicating the content of the image are similarly displayed. Moreover, in the display area 112, the image P2 shown in FIG. 26 and stored in the storage area 81C and the characters indicating the content of the image are similarly used to prepare and display the discount image. Therefore, the client contracted as the member browses the home page of the virtual shop in his own information terminal 1, 2, . . . or N, and operates a click button 113 with “Click here” displayed thereon as shown in FIG. 27 (the mouse is used to align the cursor with the button and click the button). Thus, the name of the commodity to purchase and personal data of the member himself are transmitted in the similar manner as shown in FIG. 13. In FIG. 13, there is no member number input area. But in this case, an input area of the member number or the identification number indicating that the client is the member may be disposed in addition to those shown in FIG. 13, and such data is transmitted. Furthermore, when a service image is already obtained, the image is attached to the data and the data is transmitted.

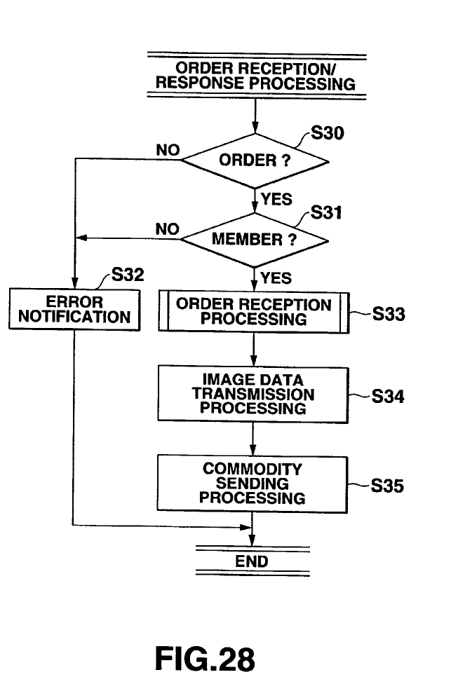

FIG. 28 shows a flowchart of an order reception and response processing in which the client transmits the order for the pizza to the virtual shop as described above, and the server apparatus 51 receives the order and transmits a response to the client. In the processing, the Web server 53 informs the managing/processing server 55 of reception of the order, and the managing/processing server 55 processes the received order according to program software stored in the ROM 62. Alternatively, the program software for executing the flow of processing may be stored in the ROM 62 of the Web server 53, and the Web server 53 executes the processing.

It is judged in step S30 whether or not received data is pizza order data. With the order data, it is judged in the next step S31 whether or not the order is transmitted from the already registered member, by comparing the transmitted member data with the data stored in the member data memory 61. When the order is transmitted from the member, the flow advances to an order reception processing of step S33. When the data is not transmitted from the member, or when it is judged in the step S30 that the order data is not normal, the flow advances to step S32, in which the client having transmitted the data is notified of an error.

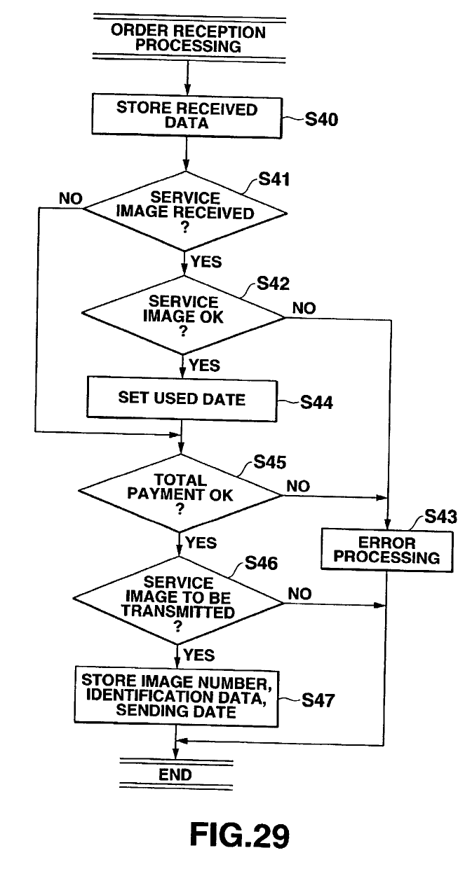

Detailed steps of the order reception processing of the step S33 are shown in FIG. 29. First in step S40, the respective transmitted data are stored in the received order data memory 90. That is, received order date, client member number data, ordered commodity data, quantity, amount, and the like are stored in the corresponding storage areas of the received order data memory 90. Moreover, for the payment method, at this point of time, a method predetermined by the contract is stored. Furthermore, it is judged whether or not there is service image data to be distributed for the ordered commodity (this is judged because the storage unit stores beforehand that the service image of 10% OFF is given to the order for two 3,000-yen pizzas as shown in FIG. 27). When there is the service image data to be distributed, the image number of the service image data is stored in the service image storage area 97. For example, when the client orders two tomato pizzas shown in FIG. 27, the client is given one service image P1 of 10% discount. Therefore, when the order for two tomato pizzas shown in FIG. 27 is transmitted from the client, it is judged that the service is applied, and the image number data 0002 of the service image P1 of 10% discount is automatically stored in the service image storage area 97.

It is then judged in step S41 whether or not the service image data is attached to the received data. When the data is attached, the identification data of the image data is stored in the payment method storage area 91 of the received order data memory 90, and the flow advances to the next step S42. That is, as described later, the identification data is attached to the image to be transmitted as the service image, and the image is transmitted. Therefore, if the received service image indicates the transmitted service image data itself, the identification data must exist in the image data. Therefore, the identification data is extracted from the image data, and the identification data is also stored in the payment method storage area 91.

It is then judged in the next step S42 whether or not the stored identification data is authentic, that is, whether or not the data is the service image data transmitted to the client having transmitted the present order during the previous order. That is, the member service image data memory 100 stores the image number of the previously transmitted image data, and the identification data attached to the image number data by the electronic watermark technique for each client as the member. It is therefore judged whether the presently received and stored identification data agrees with the identification data of the image data stored in the member service image data memory 100 and is previously transmitted to the member.

When the identification data agree with each other, it is verified that the service image data presently transmitted from the client is the service image data transmitted to the same client during the previous order. If the data do not agree with each other, the flow advances to an error processing of the step S43. If it is verified that the data is authentic, however, the flow advances to step S44. In this step S44, on the assumption that the image data is normal, and used in payment or settlement for the pizza order, date data of that day is written in the use date storage area 108 corresponding to the storage area of the member service image data memory 100 in which the same identification data is stored, and the flow advances to the next step S45.

For the step S45, when the flow advances to the step S45 from the step S44, it is judged whether or not a balance payment amount excluding a service amount indicated by the service image can be drawn from the contracted financial institution. When the flow advances to the step S45 from the step S41, the total amount of the ordered commodity has been drawn from the financial institution. That is, it is judged whether the total payment is OK with the service image or by the settlement of the financial institution. If the payment is OK, the flow advances to the step S46. If the payment is not OK, the flow advances to the error processing of the step S43. In the error processing of the step S43, the reason for the error is notified to the client when the service image transmitted in the step S42 is judged not to be normal, or when the total payment is judged not to be OK in the step S45.

After judging that there is no problem in payment for the ordered pizza in the step S45, it is judged in step S46 whether or not there is service image data to be transmitted to the client having transmitted the order. This is judged by judging whether there is image number data in the service image storage area 97 of the received order data memory 90. That is, in the step S40 of storing the received data, when the order for the pizza is transmitted together with the service image, the image number of the service image is stored in the service image storage area 97. Therefore, it is judged here whether or not the image number data is stored.

Subsequently, when it is judged that there is the service image to be transmitted, the flow advances to step S47. In the step S47, first the image number stored in the service image storage area 97 is stored in the image number storage area 105 of the member having transmitted the order in the member service image data memory 100. For example, in FIG. 20, for is an order for commodity “0001” by a client with member number “12 . . . 01”, the service image P1 with image number “0002”, is transmitted. In this case, first the image number “0002” is stored in the image number storage area 105 of the member having transmitted the order (member number “12 . . . 01”) in the member service image data memory 100.

Subsequently, the lower four digits of the identification number data of the service image P1 to be transmitted are changed, and the data is stored in the identification data storage area 106. That is, identification data “ID220000” is applied to the image number “0002” as stored in the identification data storage area 84 of the image data memory 80 of FIG. 19. Moreover, the data is distinguished from the other image data by the upper four digits “ID22” of the data.

Therefore, to store the identification data of the image number “0002” in the identification data storage area 106 of the member service image data memory 100, the upper four digits “ID22” are used as they are. Even with the same image number “0002”, for the lower four digits, the same number is avoided, and the digits are changed during numbering for each transmission to the client. That is, when the image number “0002”, is transmitted as the service image data for a first order, the identification data “ID220001” is transmitted. When the service image data is transmitted for the next order, the lower four digits are successively changed, and the identification data “ID220002” is transmitted. In this case, even with the image data of the same image number “0002”, 9999 service images can be transmitted by changing the identification data. After the identification data is stored in the identification data storage area 106 in this manner, the date on which the data is transmitted is stored in the sending date storage area 107, and the order reception processing thereby ends.

After the order reception processing of FIG. 29 ends, the flow advances to an image data transmission processing of step S34 of FIG. 28. In the image data transmission processing, the service image is actually transmitted to the client having transmitted the order. The image data P1 with the image number stored in the image number storage area 105 of the member service image data memory 100, for example, with the image number “0002” as described above is read from the image data storage area 81B of the image data memory 80. The identification data stored in the identification data storage area 106 in accordance with the image number, for example, the identification data “ID220087” as described above is attached to the read image data, for example, in a watermark state using the electronic watermark technique. Alternatively, to further enhance security, the identification data “ID220087” is subjected to a special encryption processing, encrypted and attached to the image data in the electronic watermark state. The image data is then transmitted to the client having transmitted the order (the client with the member number 12 . . . 01 in the above example) via electronic mail.

In the next step S35, a commodity sending processing for cooking and sending the ordered commodity, that is, the tomato pizza shown in FIG. 27 is performed, and the order reception and response processing thereby ends.

As described above, in the second embodiment, the image data displayed on the network can be treated as the service image which can be used as the discount ticket for discounting a selling price, exchange ticket for use to be exchanged for the commodity, coupon ticket used as one of a plurality of coupon tickets to be collected for obtaining a special privilege, point ticket or another service ticket.

Additionally, similarly as the first embodiment, the service image of the second embodiment can be utilized as a prize for the winner of the quiz or the like, a free present, or a reward for the applicant for the commodity monitor. Moreover, the service image data can be stored in recording mediums such as a floppy disk, and a semiconductor (IC) memory, and mailed to the client, or handed over to the client at a service window or the like.

The aforementioned first and second embodiments of the present invention can variously be applied or modified. For example, the virtual shop is opened in the home page of the sales company. However, when a specific corporation (such as a service company) collects commodities of many corporations and opens the virtual shop, the present invention can be applied here.

Moreover, instead of the personal computers 1, 2, . . . , N, the client information terminal may be, for example, a portable hady phone or a portable personal digital assistance (PDA).

As described above, in the present invention, the image data is transmitted to the purchaser client beforehand. When the purchaser client transmits the image data including the money amount, it can be verified whether or not the image data is normal or authentic. Therefore, the purchaser client can use the image data to perform settlement for commodity purchase on the network, and the purchaser client can use the image data to buy the arbitrary commodity on the network. Alternatively, on a selling side which has transmitted the image data to the purchaser client, it is verified whether or not the same data as the transmitted image data has been received before the settlement, and the image data can be prevented from being mistaken or abused.

1. A settlement system comprising:
transmission means for transmitting image data including a money amount to a purchaser client via a network;
reception means for receiving the image data including the money amount from the purchaser client via the network;
verification means for checking whether or not the image data including the money amount received from said purchaser client via the reception means is that transmitted image data including the money amount; and
settlement means for allowing said purchaser client to settle an account in a range of said money amount via the image data including the money amount when the verification means verifies that the image data is that transmitted image data including the money amount.

2. The settlement system according to claim 1, wherein said transmission means transmits said image data including the money amount to a winner client among a large number of clients having applied for participation in a questionnaire or a quiz or as a commodity monitor via said network.

3. The settlement system according to claim 1, wherein said transmission means attaches predetermined encryption data to said image data and transmits the image data, and said verification means verifies said image data including the money amount by judging whether or not said predetermined encryption data is attached to the image data including the money amount received from said purchaser client via said reception means.

4. The settlement system according to claim 3, wherein the encryption data is attached by electronic watermark means.

5. The settlement system according to claim 1, wherein said transmission means and said reception means comprise electronic mail means.

6. A settlement system in which a virtual shop is opened on a network and a purchaser client purchases a commodity and settles a purchase in said virtual shop, said settlement system comprising:
image data issuance means for issuing image data including a money amount to the purchaser client;
reception means for receiving the image data including the money amount from the purchaser client via the network;
verification means for checking whether or not the image data including the money amount received from said purchaser client via the reception means is that issued image data including the money amount; and
settlement means for allowing said purchaser client to settle an account in a range of said money amount via the image data including the money amount when the verification means verifies that the image data is that issued image data including the money amount.

7. The settlement system according to claim 6, wherein said image data issuance means stores said image data including the money amount in a storage medium and issues the image data.

8. The settlement system according to claim 6, wherein said issuance means attaches predetermined encryption data to said image data and issues the image data, and said verification means verifies said image data including the money amount by judging whether or not said predetermined encryption data is attached to the image data including the money amount received from said purchaser client via said reception means.

9. The settlement system according to claim 8, wherein the encryption data is attached by electronic watermark means.

10. The settlement system according to claim 6, wherein said issuance means and said reception means comprise electronic mail means.

11. A settlement system comprising:
image data issuance means for issuing image data indicating a money amount and including encryption data as a winner prize or a reward prize to a client having made an application via a network;
reception means for receiving the image data indicating the money amount from the client via the network;
verification means for checking whether or not the image data indicating the money amount received from said client via the reception means includes said encryption data; and
settlement means for settling an account in a range of said money amount of said image data when the verification means verifies that said encryption data is included.

12. The settlement system according to claim 11, wherein said issuance means attaches predetermined encryption data to said image data and issues the image data, and said verification means verifies said image data including the money amount by judging whether or not said predetermined encryption data is attached to the image data including the money amount received from said purchaser client via said reception means.

13. The settlement system according to claim 12, wherein the encryption data is attached by electronic watermark means.

14. The settlement system according to claim 11, wherein said issuance means and said reception means comprise electronic mail means.

15. A server apparatus comprising:
first image data storage means for storing image data including a money amount to be transmitted to a purchaser client via transmission means on a network;
second image data storage means for storing image data including a money amount received from the purchaser client via the network;
verification means for checking whether or not the image data including the money amount stored in the second image data storage means is the image data stored in said first image data storage means and transmitted to said purchaser client; and
settlement means for allowing said purchaser client to settle an account in a range of said money amount by the image data including the money amount when the verification means verifies that the image data is that transmitted image data including the money amount.

16. A settlement system comprising:
transmission means for transmitting an image data to a purchaser client via a network;
reception means for receiving the image data from the purchaser client via the network; and
verification means for checking whether or not said image data received from said purchaser client via the reception means is the image data transmitted via said transmission means,
wherein a predetermined service is presented to said purchaser client when said verification means verifies that the image data is that transmitted image data.

17. The settlement system according to claim 16, wherein said transmission means transmits said image data to the purchaser client having purchased a commodity in a virtual shop disposed on said network.

18. The settlement system according to claim 16, wherein said transmission means attaches predetermined encryption data to said image data and transmits the image data, and said verification means verifies the image data by judging whether or not said predetermined encryption data is attached to the image data including a money amount received from said purchaser client via said reception means.

19. The settlement system according to claim 18, wherein the encryption data is attached by electronic watermark means.

20. The settlement system according to claim 16, wherein said transmission means and said reception means comprise electronic mail means.

21. A settlement system in which a virtual shop is opened on a network and a purchaser client purchases a commodity in said virtual shop and settles the purchase, said settlement system comprising:
exhibition means for exhibiting an image data clearly indicating that a predetermined service can be received in said virtual shop;
image data issuance means for issuing said image data to said purchaser client when the purchaser client purchases the commodity in said virtual shop;
reception means for receiving the image data from the purchaser client via the network; and
verification means for checking whether or not the image data received from said purchaser client via the reception means is that issued image data,
wherein said purchaser client can receive said predetermined service when said verification means verifies that the image data is that issued image data.

22. A server apparatus comprising:
image data storage means for storing image data to be transmitted to a purchaser client via transmission means on a network;
reception means for receiving image data from said purchaser client via the network;
verification means for checking whether or not the image data received via the reception means is the image data stored in said image data storage means and transmitted to said purchaser client; and
settlement means for presenting a predetermined service to said purchaser client during settlement when the verification means verifies that the image data is that transmitted image data.

23. The server apparatus according to claim 22, wherein said transmission means transmits said image data to the purchaser client having purchased a commodity in a virtual shop disposed on said network.

24. The server apparatus according to claim 22, wherein said transmission means attaches predetermined encryption data to said image data and transmits the image data, and said verification means verifies the image data by judging whether or not said predetermined encryption data is attached to the image data including a money amount received from said purchaser client via said reception means.

25. The server apparatus according to claim 24, wherein the encryption data is attached by electronic watermark means.

26. The server apparatus according to claim 22, wherein said transmission means and said reception means comprise electronic mail means.
